(19) United States
(12) Patent Application Publication
(10) Pub. No.: US 2013/0227243 A1
(43) Pub. Date: Aug. 29, 2013

(54) INTER-PARTITION COMMUNICATION IN MULTI-CORE PROCESSOR

(71) Applicant: Vakul Garg, Shahdara (IN)

(72) Inventor: Vakul Garg, Shahdara (IN)

(73) Assignee: FREESCALE SEMICONDUCTOR, INC, Austin, TX (US)

(21) Appl. No.: 13/403,964

(22) Filed: Feb. 23, 2012

(51) Int. Cl. G06F 12/02

(52) U.S. Cl. 711/173; 711/E12.002

(57) ABSTRACT

A multi-core processor includes logical partitions that have respective processor cores, memory areas, and Ethernet controllers. At least one of the Ethernet controllers is disabled for external communication and is assigned as an inter-partition Ethernet controller for inter-partition communication. The inter-partition Ethernet controller is configured in loopback mode. A transmitting partition addresses a message through a send buffer in a private memory area to the inter-partition Ethernet controller assigned to a receiving partition. The receiving inter-partition Ethernet controller copies the received message to a receive buffer in the receiving partition's memory area. The receive Ethernet controller returns the received message to the sending partition and the sending partition resumes control of the memory space of the send buffer, or alternatively, the receive Ethernet controller frees the memory space of the send buffer to the private memory of the sending partition.

### BACKGROUND OF THE INVENTION

The present invention is directed to multi-core processors and, more particularly, to inter-partition communication in a multi-core processor.

A multi-core processor is a single computing component with two or more independent processor cores, which can run separate instructions in parallel, increasing overall speed. The cores may be included in a single integrated circuit (IC) or in more than one IC but in a single package. The different processor cores may run codes in the same operating system (OS) and may be scheduled to run code in parallel (symmetrical multi-processing—‘SMP’), sharing common memory, provided that each task in the system is not in execution on two or more cores at the same time. SMP systems can move tasks between cores to balance the workload efficiently. Alternatively, different cores may be restricted as concerns sharing specific memory and input/output (I/O) ports and may run different code in the same OS or may run different OSs (asymmetrical multi-processing—‘AMP’). A core may be dedicated to a specific OS or may be capable of working in more than one OS or may even run without an OS.

Multi-core processors may be used in many applications such as general-purpose embedded computing systems, embedded and network communications including routers, switches, media gateways, base station and radio network controllers, digital signal processing (DSP), and graphics and video processing, for example. Multi-core processors typically contain many Ethernet controllers, which are level 2 (L2) devices in the Open Systems Interconnection (OSI) model. These Ethernet controllers are usually configurable to be connected to any of the Physical layer (PHY) devices present in the multi-core processors. It is common to have more Ethernet controllers than the number of PHY devices.

A multi-core processor may include two or more logical partitions, usually each hosting a separate instance of an OS. Logical partitioning divides hardware resources so that specific cores, memory areas and I/O ports are allocated to the different partitions. The interaction between the partitions and the applications running may be managed by a hypervisor. A hypervisor organizes a virtual operating platform and manages the execution of multiple “guest” OSs running in parallel on the processor. Several guest OSs may share the virtualized hardware resources.

Communication is typically necessary between partitions, referred to as inter-partition communication. Inter-partition communication may take the form of messages or calls and may involve exchange of data and/or exchange of control signaling. Inter-partition communication may be implemented through memory area shared between the sending and receiving partitions. However, memory sharing reduces isolation of the partitions and increases risks to security, especially if the inter-partition communication opens up direct private memory access between the partitions. Also there is a risk of starvation where a partition(s) over allocates from the shared memory or loses or never frees up previously allocated memory. Sharing of memory makes system recovery complex in case of failure of partition(s) in the system. Such risks can be managed if a hypervisor is provided and mediates every inter-partition communication, but making hypervisor calls imposes overhead and can make communication slow. Thus, it would be advantageous to have a method for inter-partition communication that does not rely on shared memory.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic block diagram of a known multi-core processor showing three logical partitions and a hypervisor;

FIG. 2 is a schematic block diagram of the multi-core processor of FIG. 1 showing memory cache management and on-chip and peripheral communication connections and management;

FIG. 3 is a schematic diagram of inter-partition communication in part of a multi-core processor of the kind shown in FIGS. 1 and 2 in accordance with one embodiment of the invention, given by way of example;

FIG. 4 is a schematic diagram of inter-partition communication in part of a multi-core processor of the kind shown in FIGS. 1 and 2 in accordance with another embodiment of the invention, given by way of example; and

FIG. 5 is a flow chart of a method of operating a multi-core processor such as that shown in FIG. 3 or 4 in accordance with one embodiment of the invention, given by way of example.

### DETAILED DESCRIPTION OF PREFERRED EMBODIMENTS

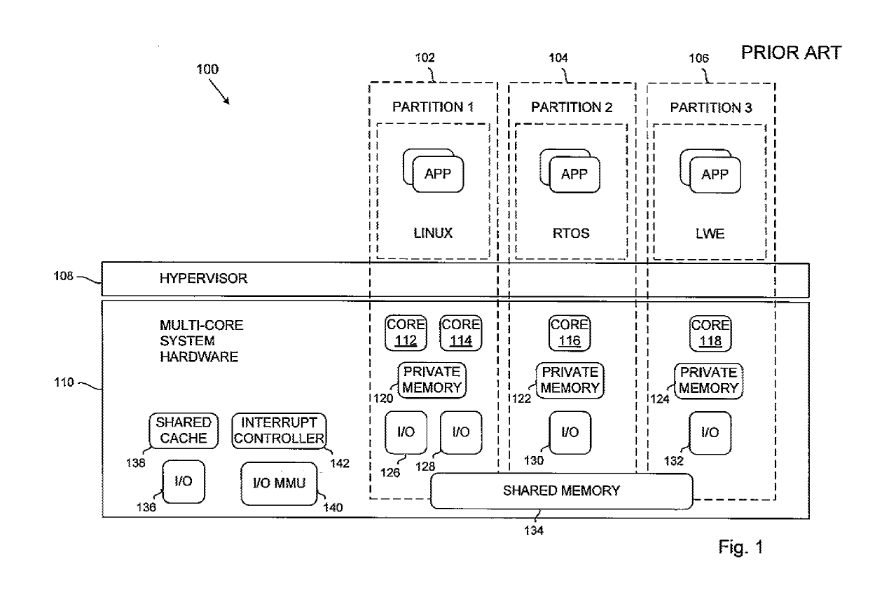

FIG. 1 illustrates a known multi-core processor 100 with logical partitions 102, 104 and 106 and a hypervisor 108 managing execution of instruction code by system hardware 110. The multi-core processor 100 is shown with three logical partitions but it will be appreciated that a different number of partitions may be provided. The logical partitions 102, 104 and 106 have respective processor cores such as 112, 114, 116 and 118, private memory areas such as 120, 122 and 124, and input/output (‘I/O’) ports such as 126, 128, 130 and 132. The system hardware 110 also includes memory area 134 shared between the logical partitions 102, 104 and 106, a common I/O port 136, shared memory cache 138, I/O memory management unit (MMU) 140 and an interrupt controller 142.

The multi-core processor 100 may run application codes in the same operating system (OS) and may be scheduled to run a code in parallel, symmetrical multi-processing mode (SMP). In this example, the multi-core processor 100 is shown with the different logical partitions 102, 104 and 106 running application codes in different guest OS's in asymmetrical multi-processing mode (AMP), with the logical partition 102 executing Linux® OS, the logical partition 104 executing a third party real time OS (RTOS) and the logical partition 106 executing a lightweight executive (LWE) OS. The hypervisor 108 presents to the guest operating systems a virtual operating platform and manages the execution of the guest operating systems. The LWE OS provides run-to-completion data plane processing, so that processes do not pre-empt each other and each process must run to completion before other processes get a chance to run.

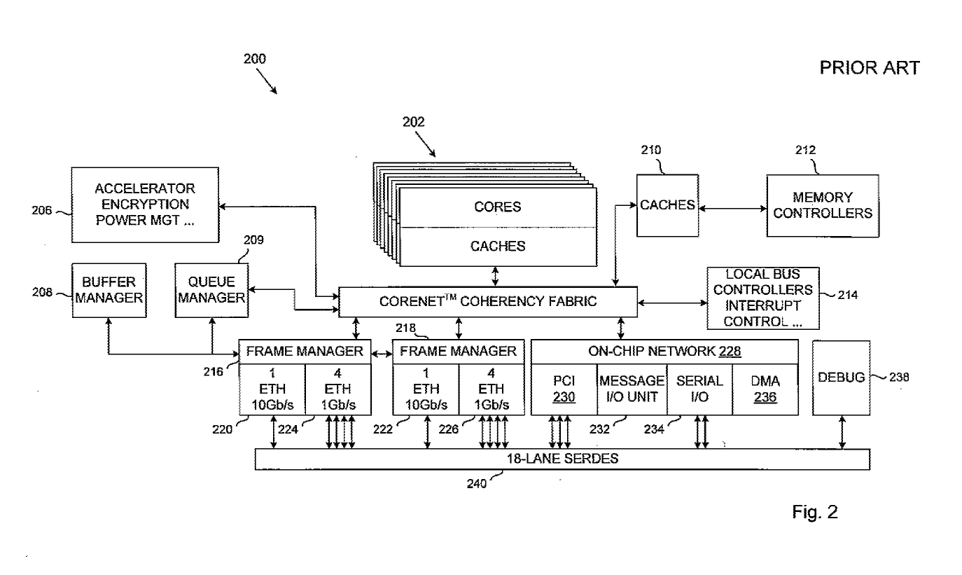

FIG. 2 illustrates in more detail hardware 200 and associated management layers in the multi-core processor 100. The hardware 200 includes a set 202 of cores such as 112 to 118 with associated private memory caches. A Corenet™ coherency fabric 204 manages coherency of the memory caches and provides on-chip and peripheral communication connections and management that supports concurrent traffic and eliminates single-point bottlenecks for non-competing resources. The Corenet™ coherency fabric 204 avoids contention and latency issues associated with scaling shared bus/shared memory architectures. The management layers for the hardware 200 include accelerator, encryption and power management modules 206, a buffer manager 208, a queue manager 209, common memory caches 210, such as the shared memory 134, memory controllers 212 and local bus controllers and interrupt control modules 214.

The hardware 200 also includes two I/O modules which include respective frame managers 216 and 218, respective 10 Gb/s Ethernet controllers 220 and 222, and respective sets 224 and 226 of four 1 Gb/s Ethernet controllers. In addition the hardware 200 includes an on-chip network 228 with a peripheral component interconnect (PCI) interface 230, a message I/O unit 232, a serial I/O unit 234 and a direct memory access (DMA) unit 236. A debug I/O unit 238 is provided for development and test work. All the I/O modules connect with a Serializer/Deserializer (SerDes) 240 for external communication, having blocks which convert data between serial data lanes and parallel interfaces in each direction. The SerDes 240 has 18 serial data lanes in this example. There may be one or more of the Ethernet controllers such as 220 to 226 which are surplus and are kept disabled because there are not enough SERDES lanes to connect to them.

In operation, inter-partition communication in one known multi-core processor of the kind shown in FIG. 1 is performed using a specific virtual I/O adapter interface and I/O operation program. The I/O operation program is under the control of supervisor/hypervisor software that initializes the message routing tables in the adapter but the supervisor/hypervisor calls impose overhead and can make communication slow. The known inter-partition communication uses a data movement protocol which is dictated by the virtual I/O adapter.

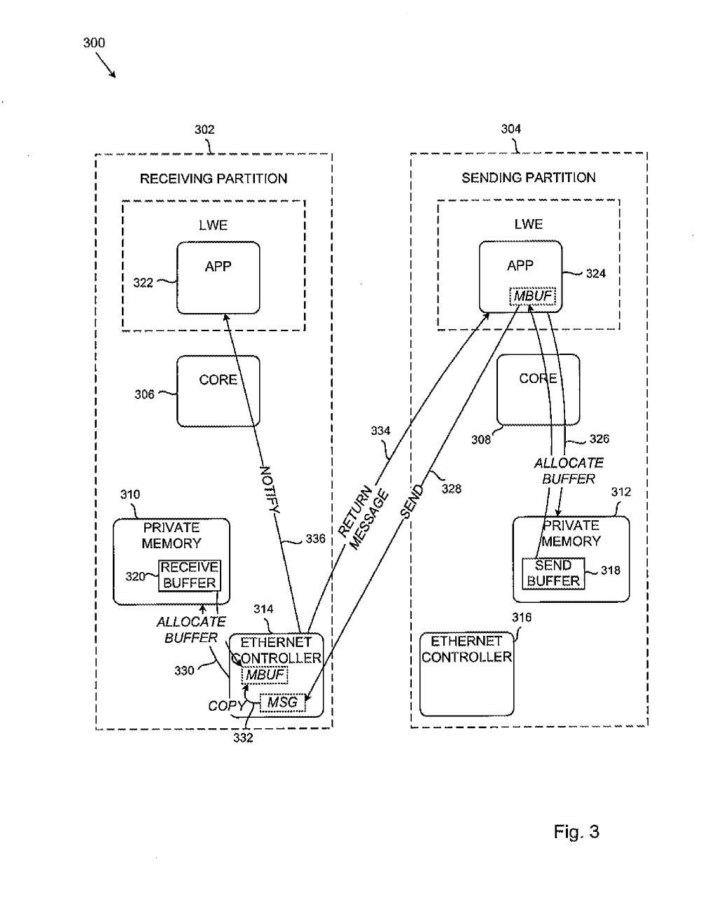

FIGS. 3, 4 and 5 illustrate part of multi-core processors 300 and 400 and a method 500 of operating a multi-core processor in accordance with embodiments of the invention, given by way of example. Each of the multi-core processors 300 and 400 includes a plurality of logical partitions 302 and 304 that have respective processor cores 306 and 308, memory areas 310 and 312, and Ethernet controllers 314 and 316. The method 500 includes disabling for external communication at least one Ethernet controller 314 of the logical partitions 302 and 304 and assigning the Ethernet controller disabled for external communication as an inter-partition Ethernet controller for reception of inter-partition communication.

In an example of the method 500, the inter-partition Ethernet controller 314 is configured in loopback mode in which it works as a DMA device in the receive mailbox of the receiving partition 302. In an example of the method 500, one of the logical partitions is configured as a transmitting partition 302 and another of the logical partitions as a receiving partition 304 having respective private memory areas. The transmitting partition 302 addresses a message MBUF through a send buffer 318 in its private memory area 312 to the inter-partition Ethernet controller 314 assigned to the receiving partition 302, under the management of the queue manager 209 for example. The receiving partition 302 copies the message MSG received in its inter-partition Ethernet controller 314 into a receive buffer 320 in the private memory area 310 of the receiving partition.

In this example of the method 500, and as illustrated in FIG. 3, the inter-partition Ethernet controller 314 of the receiving partition 302 is configured in loopback mode and after copying the received message into said receive buffer returns the received message MSG to the application 324 in the sending partition 304, under the management of the queue manager 209, notifying the sending partition of reception of the message, and the sending partition then resumes control of the memory space of the send buffer and can re-use the send buffer 318 for other messages.

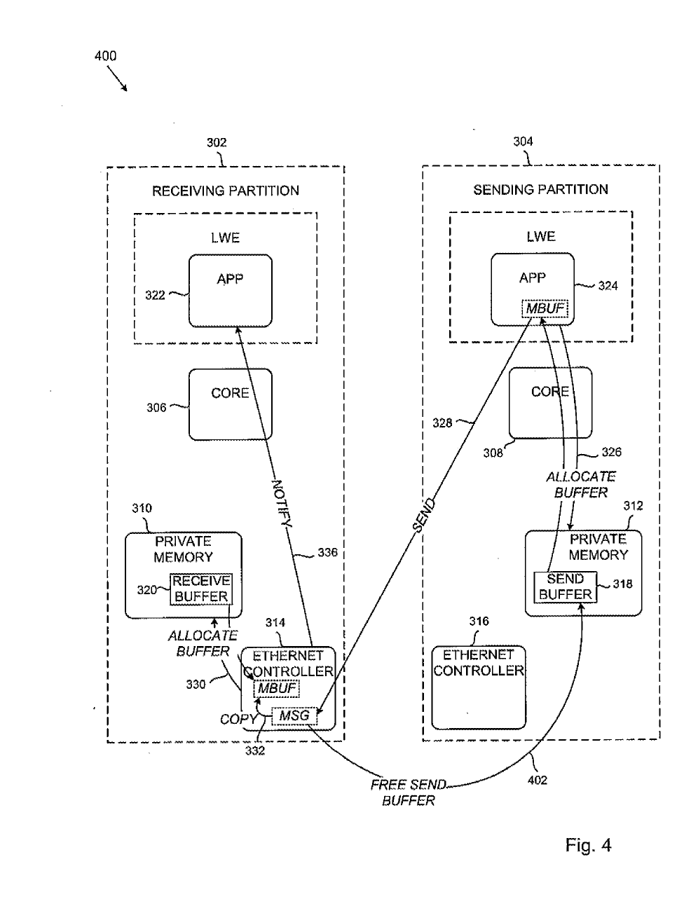

In another example of the method 500, and as illustrated in FIG. 4, the inter-partition Ethernet controller 314 of the receiving partition 302 is configured in loopback mode and frees the memory space of the send buffer 318 to the private memory 312 of the sending partition after copying the received message MSG into the receive buffer 320, by instructing the buffer manager 208.

In this example of the method 500, the receiving partition 302 copying the message MSG received in its inter-partition Ethernet controller 314 into a receive buffer 320 includes the receiving partition 302 allocating the receive buffer 302 from its memory area 310 and its inter-partition Ethernet controller 314 copying the message MSG received into the allocated receive buffer 302, the inter-partition Ethernet controller 314 and the receive buffer 302 forming a receive mailbox for the inter-partition message.

In more detail, in this example of the multi-core processors 300 and 400, application codes 322 and 324 are running in the partitions 302 and 304 under the LWE OS and the multi-core processor 300 is enabled for reconfigurable data path acceleration (DPA) operation. Ethernet controllers that are disabled for external communication, for example if the current device configuration leaves insufficient SerDes lanes for those Ethernet controllers, or because of device errata, are identified. A respective one of the Ethernet controllers identified as suitable for the inter-partition communication is then assigned to each of the logical partitions 302 and 304 in loopback mode. The buffer manager 208 can then allocate receive buffers such as 318 and 320 for the logical partitions 302 and 304 from their private memory 310 and 312, forming mailboxes for messages.

When the sending partition 304 defines a message to be sent to the receiving partition 302, the sending partition 304 instructs the buffer manager 208 to allocate space in its private memory 312 to the send buffer 318, as shown by the arrows 326. The message to be sent MBUF is registered in the send buffer 318 and queued through the queue manager 209 to the inter-partition mailbox receive Ethernet controller 314, as shown by the arrows 328. The receive Ethernet controller 314 in the receiving partition 302 then instructs the buffer manager 208 to allocate space in its private memory 310 for the receive buffer 320, as shown by the arrows 330 and copies the received message MSG into the receive buffer 320 as message MBUF, as shown by the arrow 332. In the processor 300, the receive Ethernet controller 314 then returns the received message MSG to the application 324 in the sending partition 304 under the management of the queue manager 209, notifying the sending partition of reception of the message, and the sending partition 304 then resumes control of the memory space of the send buffer 318. Alternatively, in the processor 400, the receive Ethernet controller 314 then instructs the buffer manager 208 to free the send buffer 318 to the private memory 312 of the sending partition 304, as shown by the arrow 402. In each case, the receive Ethernet controller 314 then notifies the application 322 of the received message MBUF, as shown by the arrow 336.

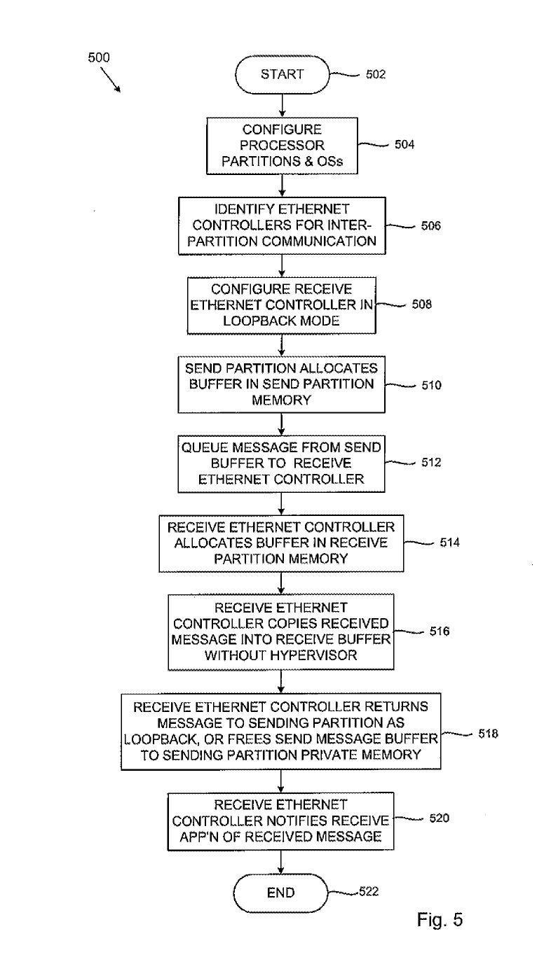

The method 500 of operating a multi-core processor is summarized in the simplified flow chart of FIG. 5. The method starts at 502. At 504, the partitions and OSs of the multi-core processor are configured. At 506, Ethernet controllers 314 and 316 which are disabled for external communication are identified and receive Ethernet controllers 314 are configured in loopback mode at 508. At 510, the sending partition 304 instructs the buffer manager 208 to allocate space in its private memory 312 for the send buffer 318. At 512, the application 324 of the sending partition queues the message MBUF through the queue manager 209 to the receive Ethernet controller 314. The receive Ethernet controller 314 instructs the buffer manager 208 to allocate space in its private memory 310 for the receive buffer 320 at 514. At 516, the receive Ethernet controller 314 copies the received message MSG into the receive buffer 320. At 518, either the receive Ethernet controller 314 returns the received message MSG through the queue manager 209 to the sending partition 304 as loopback and the sending partition 304 then resumes control of the memory space of the send buffer 318 or the receive Ethernet controller 314 instructs the buffer manager 208 to free the send buffer 318 to the private memory 312 of the sending partition 304. At 520, the receive Ethernet controller 314 notifies the application 322 of the received message MBUF and the method ends at 522.

It will be appreciated that no cycles of core processing time are necessary to copy the message for the receiving partition 302. Also the inter-partition communication does not involve cycles of hypervisor time, and the allocation of buffers as mailboxes with the receive Ethernet controller is performed by the receiving partition 302 instructing the buffer manager 208. The Ethernet controllers 314 and 316 used for inter-partition communication are available in the processor 300 and are not specific hardware for inter-partition communication. The operation of copying the received message MSG into the receive buffer 320 can be performed by any suitable data movement protocol. More than one buffer can be allocated to receive mailboxes by a receiving partition 302, if desired. Access control to sender partition memory can be enforced using Input Output Memory Management Unit (‘IOMMU’) enabling the receiver partition to allow its inter-partition-mailbox Ethernet port to copy messages selectively from a sending partition.

The invention may also be implemented using at least portions of processor code for performing steps of a method according to the invention when run on a programmable apparatus, such as a computer system or enabling a programmable apparatus to perform functions of a device or system according to the invention. A computer program is a list of instructions such as a particular application program and/or an operating system in processor code. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

In the claims, the word ‘comprising’ or ‘having’ does not exclude the presence of other elements or steps then those listed in a claim. The terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

1. A method of operating a multi-core processor having a plurality of logical partitions, each partition including a respective processor core, memory area, and Ethernet controller, the method comprising:
disabling for external communication at least one Ethernet controller of said plurality of logical partitions; and
assigning the disabled Ethernet controller as an inter-partition Ethernet controller for reception of inter-partition communication.

2. The method of claim 1, wherein said inter-partition Ethernet controller is configured in loopback mode.

3. The method of claim 1, further comprising:
configuring one of said plurality of logical partitions as a transmitting partition and another of said plurality of logical partitions as a receiving partition, each of said transmitting and receiving partitions having respective private memory areas;
wherein said transmitting partition addresses a message using a send buffer in its private memory area to the inter-partition Ethernet controller; and
the inter-partition Ethernet controller copies the message in the send buffer to a receive buffer in the private memory area of said receiving partition.

4. The method of claim 3, wherein said inter-partition Ethernet controller is configured in loopback mode and after copying the message into said receive buffer, returns the received message to said sending partition, notifying said sending partition of reception of the message, and said sending partition then resumes control of the memory space of said send buffer.

5. The method of claim 3, wherein said inter-partition Ethernet controller is configured in loopback mode and frees the memory space of said send buffer to the private memory of said sending partition after copying the message into said receive buffer.

6. The method of claim 3, wherein said receiving partition allocates said receive buffer from its memory area and the inter-partition Ethernet controller copies the message into the allocated receive buffer.

7. A multi-core processor, comprising:
a plurality of logical partitions, each logical partition including a processor core, memory area, and Ethernet controller; and
wherein at least one Ethernet controller of said logical partitions is disabled for external communication and assigned as an inter-partition Ethernet controller for inter-partition communication.

8. The multi-core processor of claim 7, wherein said inter-partition Ethernet controller is configured in loopback mode.

9. The multi-core processor of claim 7, wherein:
one of said logical partitions is configured as a transmitting partition and another of said logical partitions is configured as a receiving partition, each of said transmitting and receiving partitions having respective private memory areas;
said transmitting partition addresses a message to said receiving partition by way of the inter-partition Ethernet controller using a send buffer in its private memory area; and
said receiving partition copies the message received by the inter-partition Ethernet controller into a receive buffer in the private memory area of said receiving partition.

10. The multi-core processor of claim 9, wherein said inter-partition Ethernet controller is configured in loopback mode and after said copying of the received message into said receive buffer, returns the received message to said transmitting partition, notifying said transmitting partition of reception of the message, and said transmitting partition then resumes control of the memory space of said send buffer.

11. The multi-core processor of claim 9, wherein said inter-partition Ethernet controller is configured in loopback mode and frees the memory space of said send buffer to the private memory of said transmitting partition after copying the received message into said receive buffer.

12. The multi-core processor of claim 9, wherein said receiving partition allocates said receive buffer from its memory area and its inter-partition Ethernet controller copies the message received into the allocated receive buffer.
